(19) United States
(12) Patent Application Publication
(10) Pub. No.: US 2005/0150340 A1
(43) Pub. Date: Jul. 14, 2005

(54) Blade having a depression for trimming/cutting articles

(75) Inventors: Randall Terry, Defiance, MO (US); Michael J. Kelly, Red Lion, PA (US); Floyd Hubbard, Affton, OH (US); Ron Wrinkle, Oakville, MO (US)

Correspondence Address: VENABLE LLP, P.O. BOX 34385, WASHINGTON, DC, 20435-9998, US

(73) Assignee: Graham Packaging Company, L.P., York, PA (US)

(21) Appl. No.: 10/752,575

(22) Filed: Jan. 8, 2004

(51) Int. Cl. B26D 1/06

(52) U.S. Cl. 83/54; 83/946

(57) ABSTRACT

A blade for trimming flash from a plastic container. The blade includes a blade body having a first side end, a second side end, a front end and a rear end, the blade body including a blade edge at the front end of the blade body between the first and second side ends, a depression on the blade body formed between the first and second side ends and encompassing the blade edge, a first sidewall formed between the depression and the first side end of the blade body, and a second sidewall formed between the depression and the second side end of the blade body.

### FIELD OF THE INVENTION

The present invention relates to a blade having a depression for trimming/cutting articles.

### BACKGROUND OF THE INVENTION

Conventional blades for trimming or cutting manufactured articles (e.g., tubes or bottles made from any suitable material including plastic or sheet metal) have a blade body including a blade edge for trimming/cutting the articles (e.g., to remove flash from molded plastic containers). The blade body can be gripped by a trimmer/cutter for pushing the blade edge against articles to trim/cut the articles. For example, FIG. 1 shows a conventional blade 110 for trimming flash from a plastic container. The blade body 170 includes a flat top surface 116, a bottom surface (not shown), a blade edge 114, and a blade point 112. The blade body 170 also has holes 118 for attachment to a cutter or trimmer assembly and to grip and push the blade 110 against the articles to be cut. When the blade 110 is pushed against articles, the blade point 112 can initially pierce/cut subject areas of the articles followed by the rest of the blade edge 114 passing through to complete the trimming/cutting process. However, in the process of trimming/cutting articles, conventional blades can often deform subject areas of articles (e.g., crushing and/or ovalization of containers). Such deformation can often interfere with subsequent processing of the articles (e.g., reaming a smooth opening on the articles). This is particularly a problem for containers having relatively thin walls. Hence, what is needed then is an improved blade for trimming/cutting articles such as a container (e.g., tube or bottle made from any suitable material including plastic material or sheet metal) that can trim/cut articles without deforming the articles and interfering with subsequent processing of the articles.

### SUMMARY OF THE INVENTION

A blade for trimming flash from a plastic container is described. The blade includes a blade body having a first side end, a second side end, a front end and a rear end, the blade body including a blade edge at the front end of the blade body between the first and second side ends, a depression on the blade body formed between the first and second side ends and encompassing the blade edge, a first sidewall formed between the depression and the first side end of the blade body, and a second sidewall formed between the depression and the second side end of the blade body.

### BRIEF DESCRIPTION OF THE DRAWINGS

The foregoing description of the invention will be apparent from the following, more particular description of an embodiment of the invention, as illustrated in the accompanying drawings wherein like reference numbers generally indicate identical, functionally similar, and/or structurally similar elements.

FIG. 1 depicts a conventional blade for trimming flash from a plastic container.

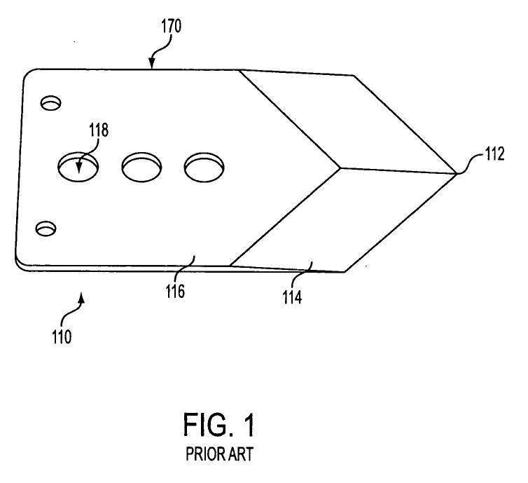

FIG. 2 depicts two plastic containers joined neck-to-neck with flash between the neck finishes, showing two blades positioned to trim the flash off according to an exemplary embodiment of the invention.

FIG. 3 depicts a blade having a depression formed on a blade body according to an exemplary embodiment of the invention.

FIGS. 4A-B illustrate the width of a blade depression in relation to areas of articles subject to cutting according to exemplary embodiments of the invention.

FIG. 5 depicts a blade having a depression and two blade points according to another exemplary embodiment of the invention.

FIG. 6 depicts a blade having a depression with a vertical rear boundary according to yet another exemplary embodiment of the invention.

FIGS. 7A-C illustrate a blade depression with a rear boundary according to exemplary embodiments of the invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

In the following description and claims, the term “article” refers to any object to be cut or trimmed by a blade and can include, for example, containers, blocks and sheets. In general, the articles to be cut or trimmed are in an intermediate stage of manufacture. For example, the article can be a plastic container with flash from the molding process still attached or a pair of containers manufactured as a single piece that must be separated. The term “container” refers to any object capable of being used to contain gas, liquid or solid material and can include, for example, tubes, jars or bottles. The term “trim” refers to any action of removing an excess or useless material from an article, and the term “cut” refers to any action to sever a material. The terms “trim” and “cut” are used interchangeably herein. Thus, reference to “cutting” is not intended to be limited to severing a material but includes trimming or removing excess material.

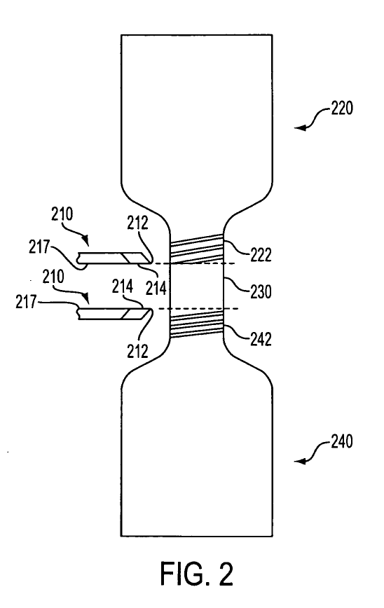

FIG. 2 depicts two plastic containers 220, 240 joined neck-to-neck with flash or moil 230 between the neck finishes 222, 242 and the positioning of two blades 210 to separate the containers and trim the flash 230 off according to an exemplary embodiment of the invention. Two plastic containers 220, 240 and two blades 210 are depicted, for example, to perform a double-cut, but any number of articles or containers (e.g., including one and more than two) and any number of blades 210 (e.g., including one and more than two) can be used to trim the article(s). The articles can be made of any suitable material that can be trimmed by blades 210 including plastic and sheet metal. The blades 210 can be conventional blades or blades according to the invention which will be described subsequently. The bottom surfaces 217 of the blades 210 can face each other as depicted, the top surfaces of the blades 210 can face each other, a bottom surface of one blade 210 can face a top surface of the other blade or any other arrangement of the blades is also possible. For making a single cut on the flash or moil of the bottle finish, the bottom surface of the blade may be oriented toward the container. As a result, any deformation of material, which is generally caused by the sloping blade edge of the blade 210, occurs in the waste portion. However, when two blades 210 are used to make a double cut on a joining region (e.g., flash) between two containers that are formed simultaneously and joined at the neck (in, e.g., a dual parison system (see U.S. patent application Ser. No. 09/814,793, filed on Mar. 23, 2001 and incorporated herein by reference)), the bottom surfaces 217 of the blades 210 may be oriented away from the containers as depicted in FIG. 2. When the two blades 212 have their bottom surfaces 217 oriented toward the containers 220, 240, the sloping blade edges of the blades 210 would crush and contort the flash 230 to the extent where a clean and precise cut can no longer be made by the blades 210. Thus, by having the bottom surfaces 217 of the blades 210 oriented toward the containers 220, 240, the impact on the flash 230 applied by the blades 210 can be reduced and a clean and precise double cut can be made.

Blade points 212 of the blades 210 are located at the bottom of the blades 210 and can be used to pierce/cut subject areas of articles. When one or more blades 210 is pushed against subject areas of articles, conventional blades can often deform the subject areas of the articles and interfere with subsequent processing of the articles. For example, pushing conventional blades against the depicted neck finishes 222, 242 of plastic containers can often cause crushing and/or ovalization of the neck finishes and interfere with reaming operations of the neck finishes to create smooth openings on the neck finishes 222, 242 or prevent with the proper fitting of caps and closures.

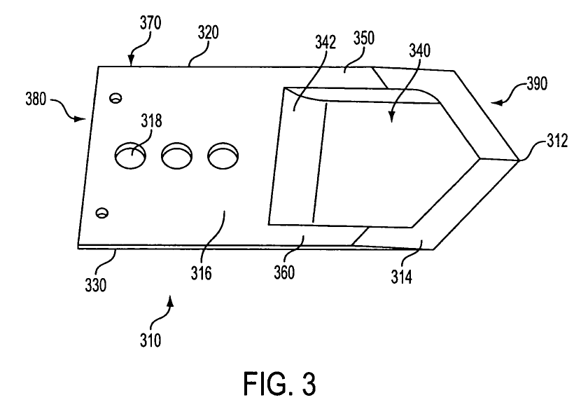

FIG. 3 depicts a blade 310 having a depression 340 according to an exemplary embodiment of the invention. By having the depression 340 formed on a blade body 370, any deformation of areas of articles that are subject to the cutting can be reduced or eliminated. The blade body 370 can include side ends 320, 330, a front end 390, a rear end 380, a top surface 316, a bottom surface (not shown), a blade edge 314, and a blade point 312. The blade body 370 can be of any length including about 1-4 inches long and more specifically 2 inches and can be of any width including about 0.75-4.0 inches and more specifically 1.5 inches and 2 inches. The blade body 370 can be adopted for being installed in any trimmer/cutter or blade support (for example, a gib manufactured by Duplicraft for installation in a Lyle trimmer). The blade body 370 can have optional holes 318 for enabling a cutter/trimmer to grip the blade and push it against articles.

The depression 340 is formed on the blade body 370 and encompasses the blade edge 314. The depression 340 has a rear boundary 342 forming a boundary between the depression 340 and the blade body 370. The depression 340 can form any surface including flat, uneven and curved surfaces. The depression 340 can be of any depth including about 0.03-0.12 inches and more specifically 0.06 inches. The depression 340 can cover more than half of the width of the blade body 370 or, alternatively, less than half of the width of the blade body 370. The width of the depression 340 can be larger than the width/diameter of a subject area of an article where the trimming occurs. Alternatively, the width of the depression 340 can be smaller than the width/diameter of a subject area of an article where the trimming occurs.

Sidewalls 350, 360 are formed between the depression 340 and the side ends 320, 330 of the blade body 370. The blade edge 314 can have any number of blade edges including one, two, or more. The blade point 312 can be located at any point along the blade edge 314 including a substantially middle point between the first and second side ends 320, 330 of the blade body 370 or as an extremity of the blade edge 314. Alternatively, the blade 310 can have two or more blade points (e.g., two blade points at opposite ends of the blade edge 314) formed as extremities of the blade edge 314. The blade edge 314 is sloped and can have any slope including varying, linear and infinite slopes. The blade edge 314 can extend from one of the top and bottom surfaces of the blade 310 to the other one, wherein the extension can be through the entire height between the two surfaces or a partial extension. The blade edge 314 can extend between the side ends 320, 330 of the blade body 370, wherein such extension can be across the two side ends 320, 330 or partially.

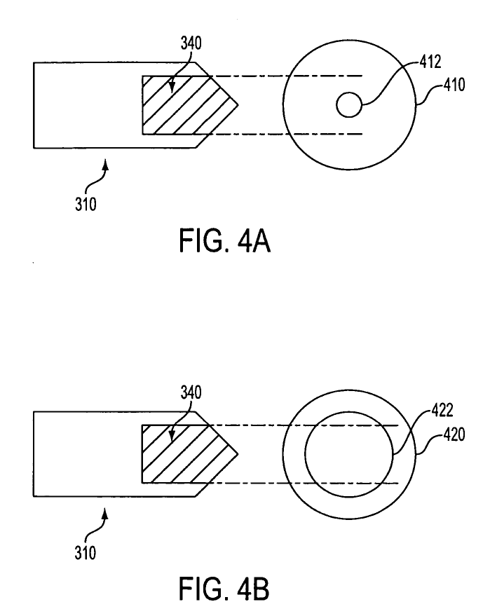

FIGS. 4A-B illustrate the width of a blade depression in relation to areas of articles subject to cutting according to exemplary embodiments of the invention. In FIG. 4A, the width of the depression 340 of the blade 310 is larger than the width/diameter of a neck finish 412 of a container 410 where the cutting occurs. In FIG. 4B, the width of the depression 340 of the blade 310 is smaller than the width/diameter of a neck finish 422 of a container 420 where the cutting occurs.

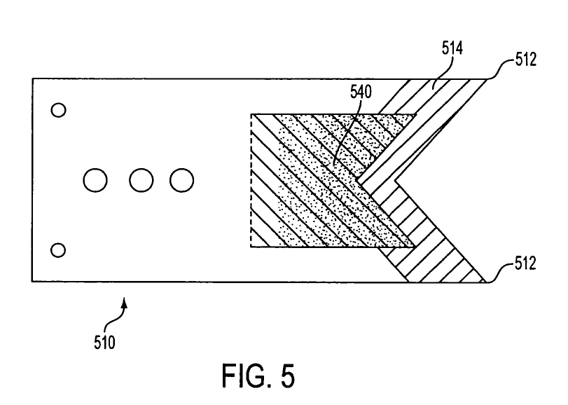

FIG. 5 depicts a blade 510 having a depression 540 and two blade points 512 according to another exemplary embodiment of the invention. The blade 510 is the same as the blade/blade body in FIG. 3 except for having two blade points 512 at opposite ends of a blade edge 514 as extremities of the blade edge 514. The description of the blade in FIG. 3 also applies to the blade 510 in FIG. 5 except where inconsistencies may arise. By not having a center blade point as in the blade/blade body of FIG. 3, which may be an initial point of contact when cutting articles and may be subject to a constant wear, the blade 510 may have a longer lifetime of usage.

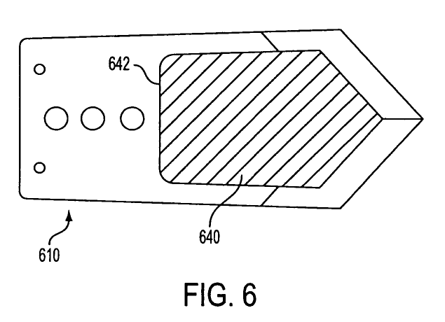

FIG. 6 depicts a blade 610 having a depression 640 with a vertical rear boundary 642 according to yet another exemplary embodiment of the invention. The blade 610 is the same as the blade in FIG. 3 except that the depression 640 has the rear boundary 642, which is vertical and has a substantially infinite slope. The description of the blade in FIG. 3 also applies to the blade 610 in FIG. 6 except where inconsistencies may arise.

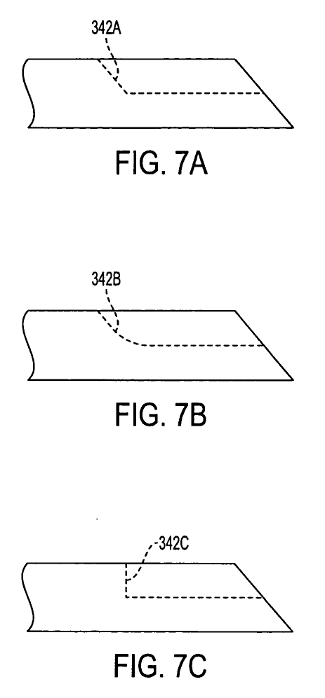

FIGS. 7A-C illustrate a blade depression with a rear boundary according to exemplary embodiments of the invention. In FIG. 7A, a rear boundary 342A of a blade depression according to an exemplary embodiment of the invention has a linear slope. In FIG. 7B, a rear boundary 342B of a blade depression according to an exemplary embodiment of the invention has a varying or curved slope. In FIG. 7C, a rear boundary 342C of a blade depression according to an exemplary embodiment of the invention has an infinite slope.

As to a method of trimming articles using blade bodies such as the blade body 370 according to the invention, the description of using blade bodies in FIG. 2 applies except where inconsistencies may arise. Initially, an article such as a container can be placed at a trimming location and trimmed with a blade as described herein. The article can be placed by transporting a preformed article to the trimming location or by forming the article at the trimming location. The article can be formed by any suitable method known in the art including, but not limited to, extrusion blow molding, stretch blow molding, injection molding, injection blow molding, and compression molding. Trimming an end (e.g., a neck finish or bottom end) of an article such as a container can include pushing the blade through the end of the container with a depression of the blade facing the body (e.g., a neck finish) of the container. Alternatively, the trimming an end (e.g., a neck finish or bottom end) of an article such as a container can include pushing the blade through the end of the container with a depression of the blade facing away from the body (e.g., a neck finish) of the container. Surprisingly, the thin portion of the blade does not result in a higher incidence of breakage. Experimental prototypes have lasted as long as conventional blades. Other surprising results may include a reduction in the time required to re-sharpen the blade edge.

The blade depression 340 can be formed at the same time that the blade body 370 is formed or at a subsequent time. The formation of the blade depression 340 after the blade body 370 is manufactured can be done by removing from the blade body 370 an area corresponding to the depression 340 by any known removal method including cutting with a blade, chiseling, burning, sanding, and laser cutting. When the blade depression 340 is formed on a preformed blade body 370, the blade 310 can have the following, non-limiting features of the invention: (1) saving research and manufacturing costs by modifying available blade bodies instead of independently manufacturing blade bodies 370 with depressions 340 according to the invention; and (2) ability to use available conventional trimmers/cutters and conventional blade supports such as a gib because an area of the blade body 370 (e.g., the blade centerline between the side ends 320, 330, the thickness of the blade body 370 where the blade body is mounted on the trimmer/cutter or blade support, and the blade holes 318) that couples with the conventional trimmers/cutters and/or blade supports remains the same.

Another feature of the blade 310 according to the invention is that it advantageously reduce any ovality impact on subjected areas of articles such as containers by reducing the thickness of the blade area that the subjected areas have to absorb during the trimming.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A blade for trimming flash from a plastic container comprising:
a blade body having a first side end, a second side end, a front end and a rear end, the blade body comprising a blade edge at the front end of the blade body between the first and second side ends;
a depression on the blade body formed between the first and second side ends and encompassing the blade edge;
a first sidewall formed between the depression and the first side end of the blade body; and
a second sidewall formed between the depression and the second side end of the blade body.

2. The blade of claim 1, wherein the blade edge comprises two blade edges.

3. The blade of claim 1, further comprising a blade point located at a substantially middle point between the first and second side ends as an extremity of the blade edge.

4. The blade of claim 1, further comprising two blade points located at opposite ends of the blade edge as extremities of the blade edge.

5. The blade of claim 1, wherein the blade body has a top surface and a bottom surface and the blade edge extends from one of the top and bottom surfaces to the other one.

6. The blade of claim 1, wherein the depression forms a flat surface.

7. The blade of claim 1, wherein the depression has a rear boundary with at least one of varying, linear and infinite slopes.

8. The blade of claim 1, wherein the blade edge extends across the first and second side ends.

9. The blade of claim 1, wherein the blade body is about 1-4 inches long between the front end and the rear end.

10. The blade of claim 1, wherein the blade body is about 0.75-3.0 inches wide between the first and second side ends.

11. The blade of claim 1, wherein the depression is about 0.030-0.12 inches in depth.

12. The blade of claim 1, wherein the depression extends over at least one half of the width of the blade body.

13. The blade of claim 1, wherein the blade body is adapted for installation in a container trimmer.

14. A method of trimming a container end comprising:
placing a container at a trimming location; and
trimming an end of the container with a blade comprising:
a blade body having a first side end, a second side end, a front end and a rear end, the blade body comprising a blade edge at the front end of the blade body between the first and second side ends;
a depression on the blade body formed between the first and second side ends and encompassing the blade edge;
a first sidewall formed between the depression and the first side end of the blade body; and
a second sidewall formed between the depression and the second side end of the blade body.

15. The method of claim 14, wherein the placing a container comprises forming a container.

16. The method of claim 15, wherein the forming a container comprises extrusion blow molding.

17. The method of claim 14, wherein the trimming an end of the container comprises pushing the blade through the end of the container with the depression facing a neck finish of the container.

18. The method of claim 14, wherein the trimming an end of the container comprises pushing the blade through the end of the container with the depression facing away from a neck finish of the container.

19. The method of claim 14, wherein the blade edge comprises two blade edges.

20. The method of claim 14, wherein the blade edge comprises a blade point located at a substantially middle point between the first and second side ends as an extremity of the blade edge.

21. The method of claim 14, wherein the blade edge comprises two blade points located at opposite ends of the blade edge as extremities of the blade edge.

22. The method of claim 14, wherein the blade body has a top surface and a bottom surface and the blade edge extends from one of the top and bottom surfaces to the other one.

23. The method of claim 14, further comprising installing the blade in a container trimmer.

24. The method of claim 14, wherein the placing a container at a trimming location comprises placing a pair of containers manufactured as a single piece with a joining region between the pair of containers.

25. The method of claim 24, wherein the trimming an end of the container comprises trimming off the joining region from the pair of containers to separate the two containers by using two blades.

26. The method of claim 25, wherein the trimming off the joining region comprises making a double-cut simultaneously with the two blades.

27. The method of claim 25, wherein each of the two blades comprise a blade body and a depression on the blade body and the trimming off the joining region comprises orienting the two depressions of the two blades away from each other and trimming off the joining region.

28. A method of making a blade for trimming a neck finish of a blow molded plastic container comprising:
providing a blade body that comprises a front end, a back end, a first side end and a second side end, a blade edge at the front end between the first and second side ends; and
forming a depression on the blade body between the first side end and the second side end, the depression encompassing the blade edge.

29. The method of claim 28, wherein the forming a depression is conducted with providing a blade.

30. The method of claim 28, the forming a depression comprises removing from the blade body an area corresponding to the depression.

31. The method of claim 28, wherein the forming a depression comprises forming a rear boundary of the depression with at least one of varying, linear and infinite slopes.

32. The method of claim 28, wherein the forming a depression comprises forming the depression to extend over at least one half of the width of the blade body.
